(19) United States
(12) Patent Application Publication
(10) Pub. No.: US 2026/0058476 A1
(43) Pub. Date: Feb. 26, 2026

(54) METHOD AND SYSTEM FOR UTILIZING SUPERCAPACITOR TO PARTICIPATE IN OFF-GRID BACKUP POWER REGULATION FOR WIND TURBINE GENERATOR, DEVICE AND MEDIUM

(71) Applicant: Huaneng Yangjiang Wind Power Generation Co., Ltd., Yangjiang (CN)

(72) Inventors: Yurong QIU, Yangjiang (CN); Xin ZHANG, Yangjiang (CN); Xujia WANG, Yangjiang (CN); Xurui WU, Yangjiang (CN); Jiewei HUANG, Yangjiang (CN); Jingwei CHEN, Yangjiang (CN)

(73) Assignee: Huaneng Yangjiang Wind Power Generation Co., Ltd., Yangjiang (CN)

(21) Appl. No.: 19/306,298

(22) Filed: Aug. 21, 2025

(30) Foreign Application Priority Data
Aug. 21, 2024 (CN) 2024111533681

(51) Int. Cl. H02J 3/38; H02J 3/16; H02J 3/48; H02J 3/50

(52) U.S. Cl. CPC H02J 3/388; H02J 3/16; H02J 3/48; H02J 3/50; H02J 2300/28

(57) ABSTRACT

The present disclosure provides a method and system for utilizing a supercapacitor to participate in off-grid backup power regulation for a wind turbine generator, a device and a medium, and the method includes the following steps: S1, calculating an active power allocation requirement and a reactive power allocation requirement of a target wind farm, respectively; S2, determining active allocated power and reactive allocated power for a supercapacitor and a wind turbine in each wind turbine generator according to the obtained active power allocation requirement and reactive power allocation requirement of the target wind farm; and S3, adjusting an active power target value and a reactive power target value of each wind turbine generator according to the obtained active allocated power and reactive allocated power.

### CROSS-REFERENCE TO RELATED APPLICATIONS

The application claims priority to Chinese patent application No. 2024111533681, filed on Aug. 21, 2024, the entire contents of which are incorporated herein by reference.

### TECHNICAL FIELD

The present disclosure belongs to the field of new energy power and in particular relates to a method and system for utilizing a supercapacitor to participate in off-grid backup power regulation for a wind turbine generator, a device and a medium.

### BACKGROUND

The integration of large-scale distributed wind and solar renewable energy into the power grid can replace a portion of traditional power plants and increase the proportion of renewable energy generation, thereby alleviating environmental pollution issues such as greenhouse gas emissions. However, compared to the traditional power plants, the inherent uncertainty, intermittency, and volatility of distributed renewable energy sources can affect grid stability and lead to power quality problems in the grid. Additionally, in extreme weather conditions, if a wind farm experiences a disconnection accident, such as the detachment of wind turbine generators and lines from the booster station, the yaw, pitch, and personnel elevator systems of each wind turbine may lose power. The result is that the fan cannot yaw, the pitch system cannot work, there is no lighting inside the wind turbine, or even critical data cannot be saved, communication is lost and the wind turbine cannot be controlled in the background. Such situations can easily escalate into safety incidents, causing blade fractures and turbine collapses, which seriously threaten the operational safety of the equipment in the wind farm.

When the wind farm loses its connection with the external power grid under extreme weather conditions, a backup power supply can provide electricity to the wind turbine generators and essential loads of the substations, ensuring the safety of both the generators and the wind farm. An energy storage system has the characteristic of dynamically absorbing energy and releasing it in a timely manner, which can compensate for the intermittency and volatility of the wind power, improve the controllability of the output power of the wind farm, and enhance its stability. The energy storage system can serve as a backup power system for wind turbine generators, ensuring system safety in an off-grid state.

Equipping each wind turbine generator with a decentralized energy storage backup power supply will become an important technical requirement for wind turbine generators in areas prone to extreme wind conditions in the future. This approach can effectively improve the reliability of the turbine equipment and the safety of production activities while reducing the corresponding design margins and equipment costs, thus effectively preventing enormous and incalculable economic losses caused by wind farm accidents.

However, the off-grid backup power system also faces several challenges during its application. Firstly, the energy storage technology and control technology of the off-grid backup power system still require further refinement and optimization to enhance system performance and reliability. Secondly, the cost of the off-grid backup power system remains relatively high. It is necessary to further develop key technologies for the combined operation of decentralized energy storage and wind turbine generators, while ensuring system reliability and safety, in order to reduce comprehensive operational costs. Additionally, most existing power energy storage systems adopt a centralized compensation approach, which fails to effectively enable the power grid to flexibly and reliably adapt to the fluctuations of the wind turbine generator. The reason is that the wind turbine generators, as wind power generation equipment, are often scattered in position. When issues such as uneven wind speed distribution, reduced or excessively high power factors in individual wind turbine generators, a low voltage, or line short circuits occur, existing power energy storage systems often fail to respond promptly and flexibly to grid fluctuations, resulting in relatively poor stability of these systems.

From the perspective of the prior art, the regulatory potential of energy storage backup power supplies for wind farms has far from been fully tapped. Most of the wind energy storage systems that are already in operation employ relatively simple regulatory strategies, which are typically used to reduce wind curtailment. That is, the electrical energy is stored during high-wind conditions and is discharged through energy storage during low-wind periods. Other energy storage control technologies, such as those for primary frequency regulation in wind power, generally only involve rapid charging and discharging power adjustments over short periods.

When paired with the wind turbines, the energy storage backup power supplies can promptly provide independent, long-duration, and high-power backup power support to individual wind turbines. In extreme and emergency conditions, such as when transmission lines are disconnected, they can offer rapid backup support to the wind turbine generators and enable some generators to form small microgrids, thereby enhancing the safety margin of the generators. In contrast, centralized energy storage systems would lose this capability in the event of corresponding transmission line disconnections. On this basis, the energy storage backup power supplies can be integrated with the control strategies of the wind turbine generators themselves, and work in conjunction with the main control system of the wind turbine generators to perform actions of relevant functions. By leveraging the regulatory flexibility of the energy storage system, it can expand the adjustable active power range of the wind turbine generators, improve the ability of wind power to support the system frequency, or provide reactive power support to the wind turbine generators, thus achieving voltage support at the point of grid connection.

Currently, there is a shortage of supporting technical products specifically designed for off-grid backup power regulation in wind power backup power systems. As the energy storage backup power systems for wind turbine generators become more prevalent, harnessing the regulatory flexibility of energy storage to achieve complementary integration with the characteristics of wind turbines will hold increasing application value.

### SUMMARY

The object of the present disclosure is to provide a method and system for utilizing a supercapacitor to participate in off-grid backup power regulation for a wind turbine generator, a device and a medium, which address the instability issues currently present when the energy storage systems participate in off-grid backup power for the wind turbine generators. This disclosure can enhance the frequency and voltage regulation characteristics of the system. Firstly, based on the real-time output power of the wind farm, combined with the frequency and voltage at the point of grid connection during that period, it calculates the output power of the energy storage system to achieve real-time adjustment of the active and reactive power of the wind turbine generator, resulting in smoother frequency and voltage of the main power source. Ultimately, the disclosure provides support for the system stability of the wind farm.

In order to achieve the above object, the technical solutions adopted by the present disclosure are:
the present disclosure provides a method for utilizing a supercapacitor to participate in off-grid backup power regulation for a wind turbine generator, including the steps of:
S1, calculating an active power allocation requirement and a reactive power allocation requirement of a target wind farm, respectively;
S2, determining active allocated power and reactive allocated power for a supercapacitor and a wind turbine in each wind turbine generator according to the obtained active power allocation requirement and reactive power allocation requirement of the target wind farm; and
S3, adjusting an active power target value and a reactive power target value of each wind turbine generator according to the obtained active allocated power and reactive allocated power.

Preferably, in S1, calculating the active power allocation requirement of the target wind farm specifically includes:
S11, calculating a first active power deviation target value according to a busbar frequency deviation at the current time;
calculating a change rate of the busbar frequency deviation at the current time according to the busbar frequency deviation at the current time; and
calculating a second active power deviation target value according to the obtained change rate of the busbar frequency deviation at the current time;
S12, performing summation according to the obtained first active power deviation target value and second active power deviation target value to obtain a summed value; and
subtracting real-time active power of a current target wind farm from the obtained summed value to obtain an active power correction value.

Preferably, in S1, calculating the reactive power allocation requirement of the target wind farm specifically includes:
acquiring a power factor at a point of grid connection at the current time;
calculating a reactive power compensation value according to the obtained power factor;
calculating a reactive power deviation target value of the target wind farm according to the obtained reactive power compensation value; and
subtracting the current real-time reactive power of the target wind farm from the obtained reactive power deviation target value to obtain a reactive power correction value.

Preferably, in S2, determining the active allocated power for the supercapacitor and the wind turbine in each wind turbine generator according to the obtained active power allocation requirement of the target wind farm specifically includes:
S21, counting remaining active power of the wind turbine and remaining electric power of the supercapacitor in each wind turbine generator;
S22, calculating an available active power variation amount of each wind turbine generator;
S23, calculating a weight of the available active power variation amount of each wind turbine generator; and
S24, calculating active allocated power of each wind turbine generator.

Preferably, in S2, determining the reactive allocated power for the supercapacitor and the wind turbine in each wind turbine generator according to the obtained reactive power allocation requirement of the target wind farm specifically includes:
counting the available capacity of the supercapacitor in each wind turbine generator;
calculating a weight of the supercapacitor in each wind turbine generator; and
calculating the reactive allocated power of the supercapacitor in each wind turbine generator according to the obtained weight.

Preferably, in S3, adjusting the active power target value of each wind turbine generator according to the obtained active allocated power specifically includes:
acquiring wind condition information of each wind turbine generator, calculating an active power output ratio according to a wind speed at the position of each wind turbine generator and the residual electric power of the supercapacitor corresponding thereto, calculating an active power target value corresponding to the wind turbine and the supercapacitor in each wind turbine generator according to the active power output ratio.

A system for utilizing a supercapacitor to participate in off-grid backup power regulation for a wind turbine generator, including:
a power allocation requirement calculation unit, configured to calculate an active power allocation requirement and a reactive power allocation requirement of a target wind farm, respectively;
a generator allocated power determining unit, configured to respectively determine active allocated power and reactive allocated power for a supercapacitor and a wind turbine in each wind turbine generator according to the obtained active power allocation requirement and reactive power allocation requirement of the target wind farm; and
a generator power target value adjusting unit, configured to adjust an active power target value and a reactive power target value of each wind turbine generator according to the obtained active allocated power and reactive allocated power.

A computer device, including:
a processor adapted to execute a computer program; and
a computer-readable storage medium having stored therein a computer program which, when executed by the processor, performs the method.

A computer-readable storage medium having stored thereon a computer program which, when executed by a processor, implements the method.

A computer program product, including a computer program which, when executed by a processor, implements the method.

Compared with the prior art, the beneficial effects of the present disclosure are:
the method for utilizing a supercapacitor to participate in off-grid backup power regulation for a wind turbine generator provided by the present disclosure offers a stable frequency and voltage regulation approach for the energy storage backup power supply of wind turbine generators during off-grid operation. It can expand the application of supercapacitors in wind turbine generators, and effectively reduce frequency and voltage fluctuations in off-grid operation of wind farms, thereby enhancing the overall economic benefits of wind farm operation. Moreover, the implementation of this method is relatively straightforward, and the present disclosure can save costs associated with high-voltage transformers, high-voltage lines, high-voltage switching equipment and secondary devices, containers, and infrastructure construction by connecting to the lines on the low-voltage side of the box-type transformer of the wind turbine generator, with cost savings reaching up to 20%. Against the backdrop of increasingly stringent assessments for new energy grid integration, this method will assume greater significance and possess increasing market value.

### BRIEF DESCRIPTION OF DRAWINGS

FIG. 1 is an overall flow framework of the present disclosure.

FIG. 2 is a schematic diagram showing the distribution of an active power target value.

FIG. 3 is a schematic diagram showing the operation of a wind storage energy management system.

### DETAILED DESCRIPTION OF THE EMBODIMENTS

In the following description, specific details such as specific system structures, techniques, and the like are presented for the sake of illustration and not limitation, in order to thoroughly understand the embodiments of the present application. However, it will be apparent to those skilled in the art that the present application may be implemented in other embodiments without these specific details. In other instances, detailed descriptions of well-known systems, devices, circuits, and methods are omitted so as not to obscure the description of the present application with unnecessary details.

### Embodiment 1

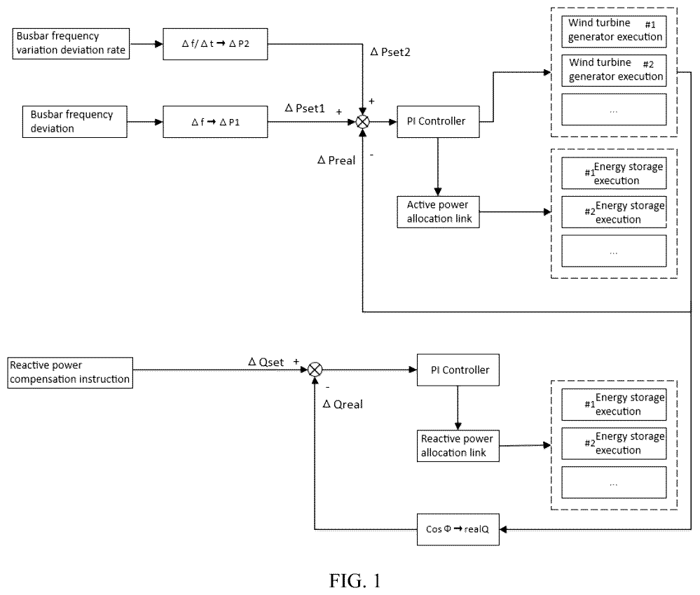

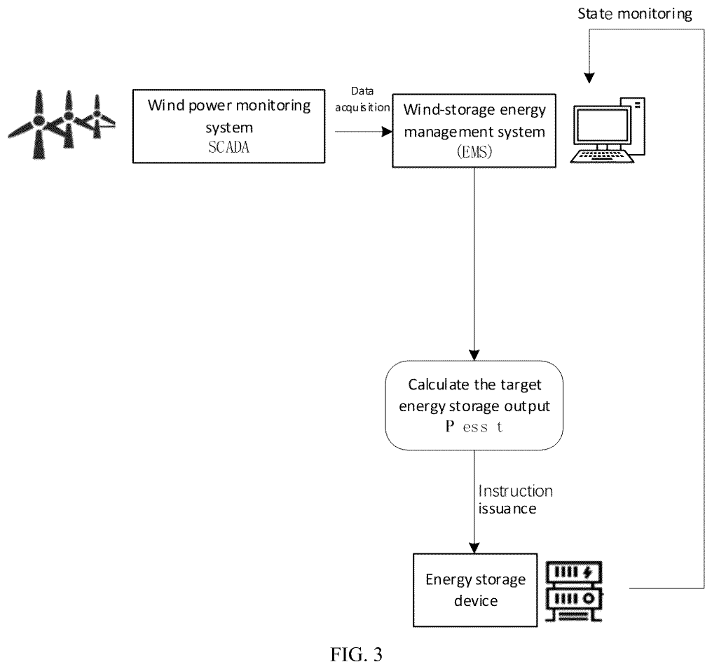

As shown in FIGS. 1 to 3, the method for utilizing a supercapacitor to participate in off-grid backup power regulation for a wind turbine generator provided by the present disclosure aims to mitigate the impact of the randomness in the output power of the wind turbine generators on the power grid. Given the different priorities in frequency regulation calls between the wind turbines and energy storage devices based on the varying focuses of power system requirements, corresponding frequency regulation control strategies need to be formulated according to actual conditions to coordinate and regulate the output of various components. Meanwhile, to achieve reactive power regulation for decentralized energy storage, the energy storage management system needs to obtain reactive power dispatching instructions, power factor instructions, or voltage control instructions from the Automatic Voltage Control (AVC) system. These instructions are then converted into the required reactive power output values through internal algorithm calculations. Subsequently, the energy management system distributes the specific reactive power instructions to each energy storage unit.

Wherein, the AVC (Automatic Voltage Control) is an automated system used for voltage and reactive power control in power systems. It is designed to ensure the safe, stable, and economic operation of the power grid by continuously monitoring and adjusting voltage and reactive power levels in real-time.

The core energy storage dispatching model of the present disclosure adopts a method that calculates and allocates the active power requirement and reactive power requirement by combining the grid frequency deviation and voltage deviation. For the actual output power of the wind farm at any given time point, dispatching and allocation are performed based on the corresponding frequency deviation and active power requirement at that time point, as well as the wind speed and the output margin considering the state of charge (SOC) of the supercapacitors. At high wind speeds, the energy storage power source primarily participates in frequency regulation, with the wind turbine generators operating under Maximum Power Point Tracking (MPPT) control. At medium to low wind speeds, the wind turbine generators primarily provide frequency regulation support, while the energy storage power source assists in the rotor speed recovery process. Subsequently, the reactive power loss is calculated based on the power factor of the wind turbine generators, and real-time reactive power compensation is carried out using the remaining capacity margin of the supercapacitors.

Wherein, MPPT (Maximum Power Point Tracking) is a crucial technology used in photovoltaic power generation systems. It is designed to ensure that solar panels consistently output electrical energy at their maximum power under varying environmental conditions, such as changes in light intensity and temperature, thereby enhancing the overall power generation efficiency of the system.

The present disclosure provides a method for utilizing a supercapacitor to participate in off-grid backup power regulation for a wind turbine generator, including the steps of:
S1, an active power allocation requirement and a reactive power allocation requirement of a target wind farm are calculated, respectively;
S2, active allocated power and reactive allocated power for a supercapacitor and a wind turbine in each wind turbine generator are determined according to the obtained active power allocation requirement and reactive power allocation requirement of the target wind farm; and
S3, an active power target value and a reactive power target value of each wind turbine generator are adjusted according to the obtained active allocated power and reactive allocated power.

### Embodiment 2

On the basis of Embodiment 1, the present embodiment provides a method for utilizing a supercapacitor to participate in off-grid backup power regulation for a wind turbine generator, wherein in Step 1, the step that the active power allocation requirement of the target wind farm is calculated specifically includes:
S11, a first active power deviation target value is calculated according to a busbar frequency deviation at the current time;
a change rate of the busbar frequency deviation at the current time is calculated according to the busbar frequency deviation at the current time; and
a second active power deviation target value is calculated according to the obtained change rate of the busbar frequency deviation at the current time;
S12, summation is performed according to the obtained first active power deviation target value and second active power deviation target value to obtain a summed value; and
real-time active power of a current target wind farm is subtracted from the obtained summed value to obtain an active power correction value.

### Embodiment 3

On the basis of Embodiment 1, the present embodiment provides a method for utilizing a supercapacitor to participate in off-grid backup power regulation for a wind turbine generator, wherein in S1, the step that the reactive power allocation requirement of the target wind farm is calculated specifically includes:
a power factor at a point of grid connection at the current time is acquired;
a reactive power compensation value is calculated according to the obtained power factor;
a reactive power deviation target value of the target wind farm is calculated according to the obtained reactive power compensation value; and
the current real-time reactive power of the target wind farm is subtracted from the obtained reactive power deviation target value to obtain a reactive power correction value.

### Embodiment 4

On the basis of Embodiment 1, the present embodiment provides a method for utilizing a supercapacitor to participate in off-grid backup power regulation for a wind turbine generator, wherein, in S2, the step that the active allocated power for the supercapacitor and the wind turbine in each wind turbine generator is determined according to the obtained active power allocation requirement of the target wind farm specifically includes:
S21, remaining active power of the wind turbine and remaining electric power of the supercapacitor in each wind turbine generator are counted;
S22, an available active power variation amount of each wind turbine generator is calculated;
S23, a weight of the available active power variation amount of each wind turbine generator is calculated; and
S24, active allocated power of each wind turbine generator is calculated.

### Embodiment 5

On the basis of Embodiment 1, the present embodiment provides a method for utilizing a supercapacitor to participate in off-grid backup power regulation for a wind turbine generator1, wherein, in S2, the step that the reactive allocated power for the supercapacitor and the wind turbine in each wind turbine generator is determined according to the obtained reactive power allocation requirement of the target wind farm specifically includes:
the available capacity of the supercapacitor in each wind turbine generator is counted;
a weight of the supercapacitor in each wind turbine generator is calculated; and
the reactive allocated power of the supercapacitor in each wind turbine generator is calculated according to the obtained weight.

### Embodiment 6

On the basis of the embodiment 1, the present embodiment provides a method for utilizing a supercapacitor to participate in off-grid backup power regulation for a wind turbine generator, wherein in S3, the step that the active power target value of each wind turbine generator is adjusted according to the obtained active allocated power specifically includes:
wind condition information of each wind turbine generator is acquired, an active power output ratio is calculated according to a wind speed at the position of each wind turbine generator and the residual electric power of the supercapacitor corresponding thereto, an active power target value corresponding to the wind turbine and the supercapacitor in each wind turbine generator is calculated according to the active power output ratio.

### Embodiment 7

The working process of the method is illustrated by taking the wind farm F at a certain off-grid operating period as an example. Referring to the flow chart of FIG. 1, an active power deviation target value ΔPₛₑₜ₁ is calculated based on a busbar frequency deviation Δf at the current time, and an active power deviation target value ΔPₛₑₜ₂ is calculated by simultaneously calculating a change rate of a busbar frequency deviation Δf/Δt. The active power deviation target values are superimposed to obtain a total active power requirement value, and an active power variation amount ΔPᵣₑₐₗ actually performed by the wind farm is acquired in background through the wind power monitoring system, and then the active power instruction is adjusted in real time by detecting an execution deviation ΔPₛₑₜ₁+ΔPₛₑₜ₂−ΔPᵣₑₐₗ and using a PI controller.

Subsequently, the wind storage management system distributes active power to each generator by collecting the operating condition of each wind power generator:
first, the remaining active power P_{rem_i}=P_{theory_i}−P_{actual_i} of each wind turbine generator is counted. Wherein, P_{theory} represents the theoretical active power and P_{actual} represents the actual active power.

Then, the remaining electric power SOCᵢ of a supercapacitor backup energy storage device in each wind turbine generator is counted. Backup energy storage devices with SOC values falling within the operational range are selected, and the active power P_{c_i} corresponding to each supercapacitor backup energy storage device is calculated. For the backup energy storage devices with SOC values outside the operational range, the active power P_{c_i} for each of these supercapacitor backup energy storage devices is set to zero.

An available active power variation amount P_{ava_i}=P_{rem_i}+P_{c_i} of each generator is calculated, a weight

$${W}_{i} = \frac{{P}_{ava \_ i}}{{\sum }_{1}^{N} {P}_{ava \_ i}}$$

of the available active power variation amount of each generator is calculated, and the allocated power Pᵢ is obtained using the weight.

Finally, the wind condition information of each wind turbine generator is acquired. Based on the wind speed at the turbine position and the backup electric power of the supercapacitor energy storage system, and in conjunction with the allocated power, the active power output ratio of the wind turbine and the supercapacitor within each wind turbine generator is calculated. Then, an active power target value is issued according to the active power output ratio.

Meanwhile, the wind-storage energy management system measures the current power factor at the point of grid connection, calculates a reactive power value that needs to be compensated, and sums up the reactive power compensation value for the entire wind farm. Then, the overall reactive power regulation instruction ΔQ=ΔQₛₑₜ−ΔQᵣₑₐₗ is superimposed, and a PI controller is used to adjust the reactive power instruction in real time. When allocating the reactive power, the available capacity Qᵢ of the energy storage backup power supply of each supercapacitor is firstly calculated, and then the reactive power compensation instruction is allocated and issued based on the weight of each available capacity relative to the total available capacity.

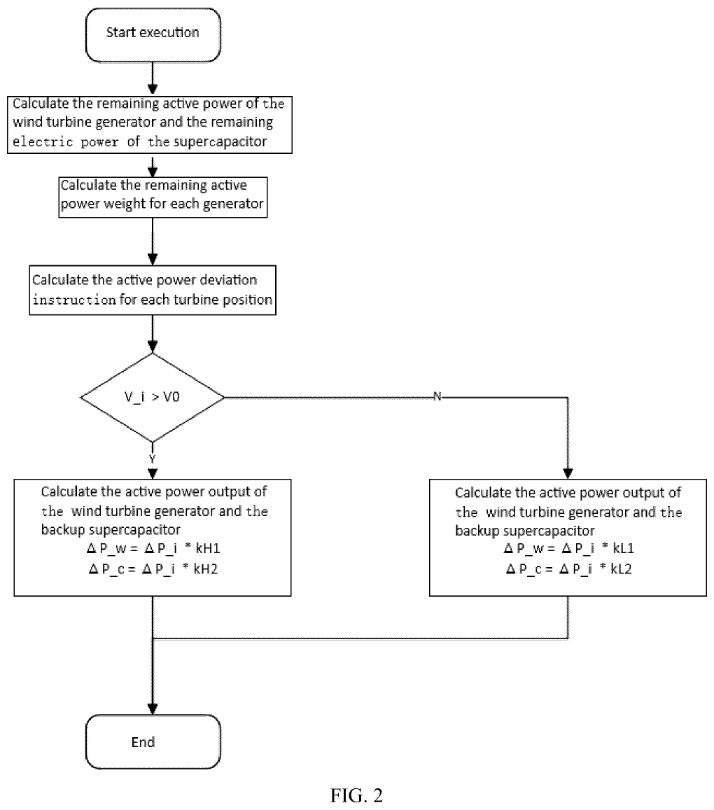

In the allocation phase, preventing overcharging or overdischarging of the supercapacitors is given top priority. The current state of charge (SOC) of the supercapacitor energy storage system is assessed to determine whether it meets the discharge and charge constraints. Once the SOC constraints are satisfied, the active power deviation is evenly distributed to each wind turbine generator. Subsequently, based on the real-time wind speed of each generator, the active power deviation target value is allocated to the main power source of the wind turbine and the backup power system of the supercapacitors. When facing a frequency drop, at low wind speeds, the kinetic energy of the wind turbine rotor is relatively small. If the wind turbine continues to participate in system frequency regulation, there is a risk of a secondary frequency dip. In such cases, the supercapacitors are prioritized to output active power. At high wind speeds, the rotor speed of the wind turbine is already high, making further speed increases difficult. Considering the rapid charging and discharging characteristics of the supercapacitors, they are also prioritized to output active power. The execution process for active and reactive power output can be referred to in FIG. 2. Wherein, P_{rem_i} represents the remaining active power of the wind turbine generator i; SOCᵢ represents the remaining charge of the supercapacitor i; Wᵢ represents the weight of the remaining active power of the wind turbine generator i; ΔPᵢ represents the active power deviation instruction; Vᵢ represents the measured wind speed of the wind turbine generator; V₀ represents the reference wind speed set value; ΔP_{w} represents the active power output of the generator; ΔP_{soc} represents the active power output of the supercapacitor; KH₁ represents the adjustment coefficient for the output of the wind turbine generator under high wind speed conditions; KH₂ represents the adjustment coefficient for the output of the supercapacitor under high wind speed conditions; KL₁ represents the adjustment coefficient for the output of the wind turbine generator under low wind speed conditions; and KL₂ represents the adjustment coefficient for the output of the supercapacitor under low wind speed conditions.

This section will take the wind farm F equipped with supercapacitor backup energy storage for each wind turbine generator as an example to describe the application solutions and effects of the method proposed in the present disclosure. The wind farm F is located in a coastal area with an installed capacity of 100 MW. During off-grid operation, the wind farm needs to ensure that the frequency and voltage of the busbar meet the requirements of internal loads. After being temporarily disconnected from the grid, abnormal busbar frequencies often occur due to changes in wind speed. The generators within the wind farm F utilize supercapacitor energy storage backup power supplies to provide electricity internally during off-grid operation. Additionally, a wind-storage energy management system is installed for controlling the backup energy storage system of the wind farm. The off-grid backup power regulation strategy program corresponding to the method of this disclosure is deployed on a decentralized wind-storage energy management system. The wind-storage energy management system collaborates with the wind farm monitoring system to achieve the operational effects of off-grid backup power regulation.

The wind-storage energy management system needs to obtain real-time active power output values of the wind farm as well as current wind speed and condition information at each turbine position from the background of the wind power monitoring system. Based on the acquired relevant data, the regulation algorithm of the wind-storage energy management system calculates the available energy and output power of the supercapacitor backup energy storage at the current moment, and then issues these instructions to the backup energy storage equipment for execution.

### Embodiment 8

The present embodiment provides a system for utilizing a supercapacitor to participate in off-grid backup power regulation for a wind turbine generator, including:
a power allocation requirement calculation unit, configured to calculate an active power allocation requirement and a reactive power allocation requirement of a target wind farm, respectively;
a generator allocated power determining unit, configured to respectively determine active allocated power and reactive allocated power for a supercapacitor and a wind turbine in each wind turbine generator according to the obtained active power allocation requirement and reactive power allocation requirement of the target wind farm; and
a generator power target value adjusting unit, configured to adjust an active power target value and a reactive power target value of each wind turbine generator according to the obtained active allocated power and reactive allocated power.

### Embodiment 9

The embodiment 9 provides a computer device including: a memory for storing a computer program; a processor for implementing the steps of a computer method when executing the computer program.

The processor, when executing the computer program, implements the steps of the computer method described above.

Or, the processor, when executing the computer program, implements the functions of the modules in the above system, and
the computer device may be a computing device such as a desktop computer, a notebook, a palmtop computer, or a cloud server. The computer device may include, but is not limited to, a processor, a memory. Those skilled in the art will appreciate that the foregoing are examples of computer devices and are not intended to be limiting, and may include more components than those described above, or a combination of some components, or different components, e.g., the computer device may also include input and output devices, network access devices, busbars, and the like.

The processor may be a Central Processing Unit (CPU), but may also be another general purpose processor, a Digital Signal Processor (DSP), an Application Specific Integrated Circuit (ASIC), a Field-Programmable GateArray (FPGA) or other programmable logic device, a discrete gate or transistor logic device, a discrete hardware component, or the like. The general purpose processor may be a microprocessor or the processor may be any conventional processor or the like, which is the control center for the computer device, and various parts of the entire computer device are connected using various interfaces and lines.

The memory may be used to store the computer programs and/or modules, and the processor implements various functions of the computer device by running or executing the computer programs and/or modules stored in the memory, and invoking data stored in the memory.

The memory may mainly include a stored program area and a stored data area, wherein, the stored program area may store an operating system, an application program required for at least one function (such as a sound playing function, an image playing function, etc.), and the like; the storage data area may store data created according to the use of the handset (such as audio data, phonebook, etc.), and the like. In addition, the memory may include a high-speed random access memory, and may also include a non-volatile memory, such as a hard disk, a memory, a plug-in hard disk, a Smart Media Card (SMC), a Secure Digital (SD) card, a Flash Card, at least one magnetic disk storage device, a flash memory device, or other volatile solid-state storage devices.

### Embodiment 10

The present embodiment 10 also provides a computer-readable storage medium storing a computer program which, when executed by a processor, implements the steps of the method.

The computer system integrated modules/units, if implemented in the form of software functional units and sold or used as independent products, may be stored in a computer readable storage medium.

Based on this understanding, the implementation of all or part of the processes in the above-described method can also be accomplished by instructing related hardware by a computer program stored in a computer readable storage medium, and when executed by a processor, the computer program can implement the steps of the above-described computer method. Wherein, the computer program includes computer program code, and the computer program code may be in a source code form, an object code form, an executable file, a preset intermediate form, or the like.

The computer-readable storage medium may include any entity or device capable of carrying the computer program code, a recording medium, a compact disc, a removable hard disc, a magnetic disc, an optical disc, a computer memory, a Read-Only Memory (ROM), a Random Access Memory (RAM), an electrical carrier signal, a telecommunication signal, a software allocation medium, and the like.

It should be noted that the content contained in the computer-readable storage medium may be appropriately increased or decreased according to the requirements of legislation and patent practice in a jurisdiction, for example, in some jurisdictions, according to legislation and patent practice, the computer-readable storage medium does not include electrical carrier signals and telecommunication signals.

### Embodiment 11

The embodiment 11 provides a computer product including a computer program, which is stored in a computer readable storage medium; a processor of a computer device reads the computer program from a computer-readable storage medium, the processor executes the computer program, so that the computer device can perform the method in Embodiment 1, which will not be described in detail herein.

It should be noted that those skilled in the art can understand that all or part of the processes in the methods of the above embodiments can be implemented by instructing related hardware through a computer program, and the program can be stored in a computer-readable storage medium, and when executed, the program can include the processes of the embodiments of the above methods.

The embodiments described above are only used to illustrate the technical solutions of the present application, but not to limit them; although the present application has been described in detail with reference to the foregoing embodiments, those skilled in the art should understand that the technical solutions described in the foregoing embodiments can still be modified, or some technical features can be equivalently replaced. However, these modifications or substitutions do not make the essence of the corresponding technical solutions deviate from the spirit and scope of the technical solutions of each embodiment of the present application, and should be included within the scope of protection of the present application.

What is claimed is:

1. A method for utilizing a supercapacitor to participate in off-grid backup power regulation for a wind turbine generator, comprising the steps of:
S1, calculating an active power allocation requirement and a reactive power allocation requirement of a target wind farm, respectively;
S2, determining active allocated power and reactive allocated power for a supercapacitor and a wind turbine in each wind turbine generator according to the obtained active power allocation requirement and reactive power allocation requirement of the target wind farm; and
S3, adjusting an active power target value and a reactive power target value of each wind turbine generator according to the obtained active allocated power and reactive allocated power.

2. The method for utilizing a supercapacitor to participate in off-grid backup power regulation for a wind turbine generator according to claim 1, wherein in S1, calculating the active power allocation requirement of the target wind farm specifically comprises:
S11, calculating a first active power deviation target value according to a busbar frequency deviation at the current time;
calculating a change rate of the busbar frequency deviation at the current time according to the busbar frequency deviation at the current time; and
calculating a second active power deviation target value according to the obtained change rate of the busbar frequency deviation at the current time;
S12, performing summation according to the obtained first active power deviation target value and second active power deviation target value to obtain a summed value; and
subtracting real-time active power of a current target wind farm from the obtained summed value to obtain an active power correction value.

3. The method for utilizing a supercapacitor to participate in off-grid backup power regulation for a wind turbine generator according to claim 1, wherein in S1, calculating the reactive power allocation requirement of the target wind farm specifically comprises:
acquiring a power factor at a point of grid connection at the current time;
calculating a reactive power compensation value according to the obtained power factor;
calculating a reactive power deviation target value of the target wind farm according to the obtained reactive power compensation value; and
subtracting the current real-time reactive power of the target wind farm from the obtained reactive power deviation target value to obtain a reactive power correction value.

4. The method for utilizing a supercapacitor to participate in off-grid backup power regulation for a wind turbine generator according to claim 1, wherein, in S2, determining the active allocated power for the supercapacitor and the wind turbine in each wind turbine generator according to the obtained active power allocation requirement of the target wind farm specifically comprises:
S21, counting remaining active power of the wind turbine and remaining electric power of the supercapacitor in each wind turbine generator;
S22, calculating an available active power variation amount of each wind turbine generator;
S23, calculating a weight of the available active power variation amount of each wind turbine generator; and
S24, calculating active allocated power of each wind turbine generator.

5. The method for utilizing a supercapacitor to participate in off-grid backup power regulation for a wind turbine generator according to claim 1, wherein, in S2, determining the reactive allocated power for the supercapacitor and the wind turbine in each wind turbine generator according to the obtained reactive power allocation requirement of the target wind farm specifically comprises:
counting the available capacity of the supercapacitor in each wind turbine generator;
calculating a weight of the supercapacitor in each wind turbine generator; and
calculating the reactive allocated power of the supercapacitor in each wind turbine generator according to the obtained weight.

6. The method for utilizing a supercapacitor to participate in off-grid backup power regulation for a wind turbine generator according to claim 1, wherein in S3, adjusting the active power target value of each wind turbine generator according to the obtained active allocated power specifically comprises:
acquiring wind condition information of each wind turbine generator, calculating an active power output ratio according to a wind speed at the position of each wind turbine generator and the residual electric power of the supercapacitor corresponding thereto, calculating an active power target value corresponding to the wind turbine and the supercapacitor in each wind turbine generator according to the active power output ratio.

7. A system for utilizing a supercapacitor to participate in off-grid backup power regulation for a wind turbine generator, comprising:
a power allocation requirement calculation unit, configured to calculate an active power allocation requirement and a reactive power allocation requirement of a target wind farm, respectively;
a generator allocated power determining unit, configured to respectively determine active allocated power and reactive allocated power for a supercapacitor and a wind turbine in each wind turbine generator according to the obtained active power allocation requirement and reactive power allocation requirement of the target wind farm; and
a generator power target value adjusting unit, configured to adjust an active power target value and a reactive power target value of each wind turbine generator according to the obtained active allocated power and reactive allocated power.

8. A computer device, comprising:
a processor adapted to execute a computer program; and
a computer-readable storage medium having stored therein a computer program which, when executed by the processor, performs the method claim 1.

9. A computer-readable storage medium having stored thereon a computer program which, when executed by a processor, implements the method according to claim 1.

10. A computer program product, comprising a computer program which, when executed by a processor, implements the method according to claim 1.
